(19) United States
(12) Patent Application Publication
(10) Pub. No.: US 2006/0184868 A1
(43) Pub. Date: Aug. 17, 2006

(54) Method for synchronizing the slide show with the background music

(75) Inventors: Yi-Kai Chen, Tainan City (TW); Cheng-Chia Chang, Gueiren Township (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/202,284

(22) Filed: Aug. 11, 2005

(30) Foreign Application Priority Data
Feb. 17, 2005 (TW) 094104684

(51) Int. Cl. G06F 17/21

(52) U.S. Cl. 715/500.1

(57) ABSTRACT

In general, the playing time of the slide show is not always just equal to that of the background music. Hence, it is desired to adjust their playing time interval. The present invention therefore provides a pleasant way to synchronize the playing time of the side show with that of the background music. First, the playing time difference between the slide show and the background music is obtained. The slide show would be divided into two segments, which are the first segment and the second segment. Each image of the first segment would be displayed together with certain image of the second segment by frame division. Therefore, a slide show with the same playing time as the background music is generated.

### FIELD OF THE INVENTION

The present invention is related to a method for synchronizing the slide show with the background music, particularly to a method which applies the technique of frame division for displaying multiple images at once to synchronize the slide show with the background music.

### BACKGROUND OF THE INVENTION

With the digitizing of image technology, the user is provided with various types of means to store the captured images or pictures in digital formation. Such means includes the popular digital camera (DC) or the scanner, which could be used to scan the traditional pictures as image files.

Besides, for the fast development of storage technology, the capacities of the memory card mainly used in the DC have become remarkably greater. Therefore, the users could capture much more pictures in one memory card. Unlike the traditional pictures, the images captured by the DC could be viewed on the computer or even the television without being printed on photographic papers in advance. Accordingly, the users may tend to take a great number of images in the places of historic interest and scenic beauty or in the occasions for celebration.

Since the pictures are still images, it is quite boring and complicated to browse numerous pictures manually one by one. To solve such problem, these pictures are usually integrated as a slide show, which could display the images automatically. In such slide show, the images may be presented with various image effects, such as zooming, panning, fade-in or fade-out.

Moreover, the background music may be provided to incorporate into the slide show for fun. The playing time of the background, however, could not always just equal to that of the slide show. The traditional way to handle such problem is simply repeating the background music and cutting off the playing in any section of the background music. Although the effect of music fade-out is provided, this way still causes suddenness and destroys the integrity of the slide show. Consequentially, the perfect visual and audio effects are therefore absent.

### SUMMARY OF THE INVENTION

In view of the above-mentioned problems, the present invention therefore provides methods for synchronizing the slide show with the background music. With these methods, various techniques could be applied to adjust the playing time of the slide show to synchronize with the background music. In this way, the integrity of the slide show and the background music could be maintained, and the users would not be displeased by the difference between the playing times.

The purpose of the present invention is providing a method for synchronizing the slide show with the background music. First, the playing times of the slide show and the background music are compared to obtain their difference. If the playing time of the slide show is longer than that of the background music, the images in one segment of the slide show (preferably the segment exceeding the background music) are displayed together with certain images in the remaining segment by means of frame division. A new slide show having the same playing time with the background music is generated. If the playing time of the slide show is shorter than that of the background music, at least one image in the slide show would be divided into plural sections, and the sections would be displayed sequentially to extend the playing time of the slide show. Similarly, the new slide show having the same playing time with the background music is generated.

Besides, the methods of the present invention may also divide plural images in the slide show into plural sections, and group these sections. The images belonging to the same group would be displayed in the same frame to adjust the playing time of the slide show. The new slide show having the same playing time with the background music is therefore generated. Moreover, different groups may include identical sections. In other words, each section could appear in several frames repeatedly to extend or shorten the playing time of the slide show.

### BRIEF DESCRIPTION OF THE DRAWINGS

FIG. 1 is the flow chart of one method of the present invention.

FIG. 2 is the flow chart of another method of the present invention.

FIG. 3 is the flow chart of still another method of the present invention.

FIG. 4 illustrates the disposition of the playing time and the frames of the preferred embodiment.

FIG. 5 illustrates the disposition of the playing time and the frames of another embodiment.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

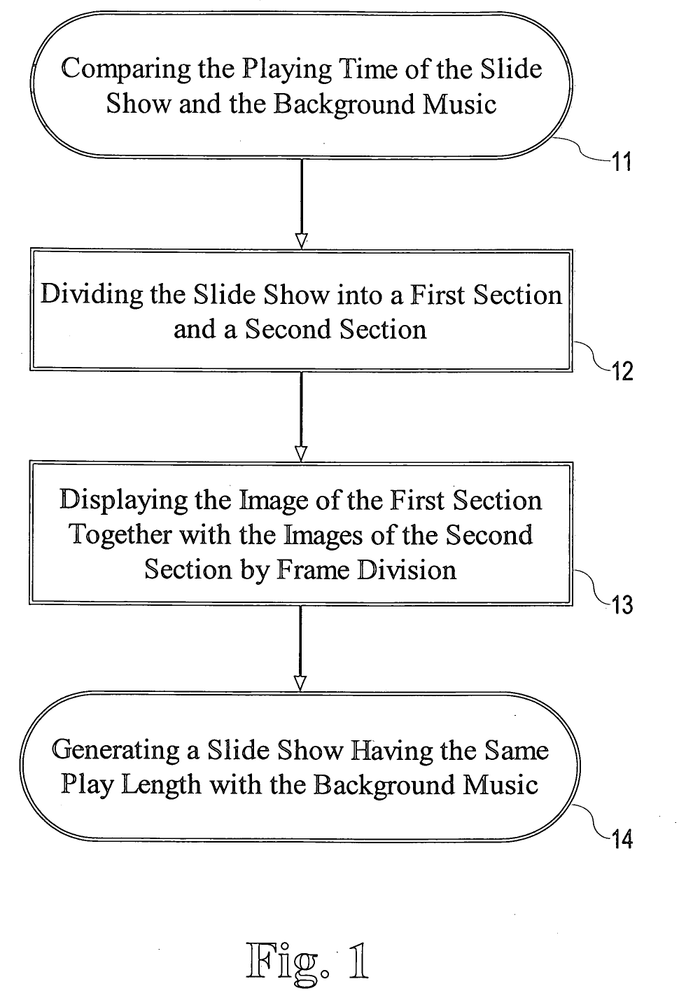

FIG. 1 is a flow chart which illustrates the preferred embodiment of the present invention. It should be appreciated that the steps of the method of the present invention may be performed by the computer or the system with a processor. Initially, the system would compare the time difference between the playing time of the slide show and the background music, which are stored in the storage device. The result of comparison is applied to determine how to adjust the playing time of the slide show, that is, the determination is used to extend or shorten the playing time of the slide show, as shown in step 11.

In this embodiment of the present invention, the storage device for storing the slide show and the background music includes but not limited to the hard disc, the floppy disc, the compact disc (such as CD, DVD, HD DVD or Blu-ray disc) or the memory (such as RAM, ROM or Flash memory).

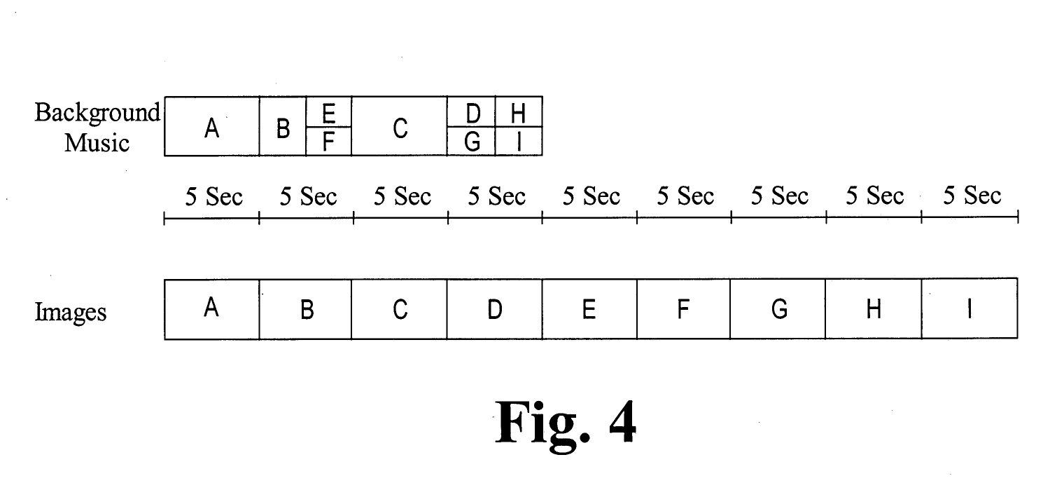

As shown in the FIG. 4, the slide show includes nine images for instance, and the playing time of each image is five seconds. Thus, the total playing time of the slide show is forty-five seconds. However, the playing time of the associate background music is only twenty seconds. In this situation, the playing time of the slide show would exceed twenty-five seconds over that of the background music. Conventionally, the background music would be repeatedly played three times, and the third playing merely lasts for five seconds. Accordingly, the playing of the background music is cut off suddenly to meet with the end of the slide show, and the viewer may therefore be displeased due to the mismatch and absurd arrangement.

In the preferred embodiment of the present invention, the slide show would be divided into plural segments, two segments for example, which are the first segment and the second segment. As shown in step 12, the first segment is preferably the exceeding segment of the slide show compared with the background music, such as the image E to I in FIG. 4, namely the images displayed in last twenty-five seconds. It should be appreciated that the first segment is not limited to the exceeding segment, but could be modified depending on various demands. For example, in another embodiment of the present invention, the first segment may include five images selected arbitrarily from the slide show.

When the background music is shorter than the playing time of slide show and the ending of the background music is not at the right time of image switch, the first segment preferably includes the displayed image at the moment. For instance, if the playing time of the background music is twenty-three seconds, the background music would be finished during the displaying of image E. In this situation, the image E is preferably included in the first segment.

The second segment may include all other images except those of the first segment. In this embodiment, the second segment includes four images, which are image A to D. Nevertheless, the distribution of the first and second segments is not limited to the aforementioned arrangement, and some images may be shared by them. For example, the first segment could include last seven images in the slide show (image C to I) and the second segment may include first five images in the slide show (image A to E). In this way, three images (image C, D and E) are shared by the first and second segments.

Next, in step 13, each image in the first segment would be displayed along with certain image of the second segment by frame division, as shown in FIG. 4. The frame division is implemented by dividing the frame originally showing certain image in the second segment into plural portions, and plural images are arranged in the plural portions. In the preferred embodiment of the present invention, the five images in the first segment may be displayed together with the images in the second segment by frame division. For example, the images in the first segment may be grouped into two sets. One set includes image E and image F, and the other set includes image C, image H and image I. Subsequently, two images are selected from the second segment, which are image B and image D. As shown in FIG. 4, by frame division, image B and all images of the former set, as well as image D and all images of the later set, are integrated in the same frame. It should be noted that the arrangement of images to frames may be implemented in various ways. Certain image could be displayed repeatedly in different frame. In one frame, the number of the portions as well as the number of displaying images may be modified to meet various demands. Moreover, the images presented in a frame may not map onto the portions in the frame. In other words, the frame may reserve some margins or blank portions which are not filled with any image. These margins could be added with various patterns, colors or visual effects.

Besides, the images displayed jointly in a frame may be displayed sequentially or concurrently. Generally, the playing time could be shortened by displaying plural images in a frame concurrently.

Since the frame is divided into smaller portions, the images arranged in the frame could be zoomed or cropped to fit the areas of the portions. In one preferred embodiment of the present invention, the portions may include a dominant portion with greater area. Such dominant portion is usually filled with the image which is originally displayed in that frame.

Finally, with the above adjustment, a new slide show having the same playing time with the background music could be generated by the computer or the processor of the system, as shown in step 14.

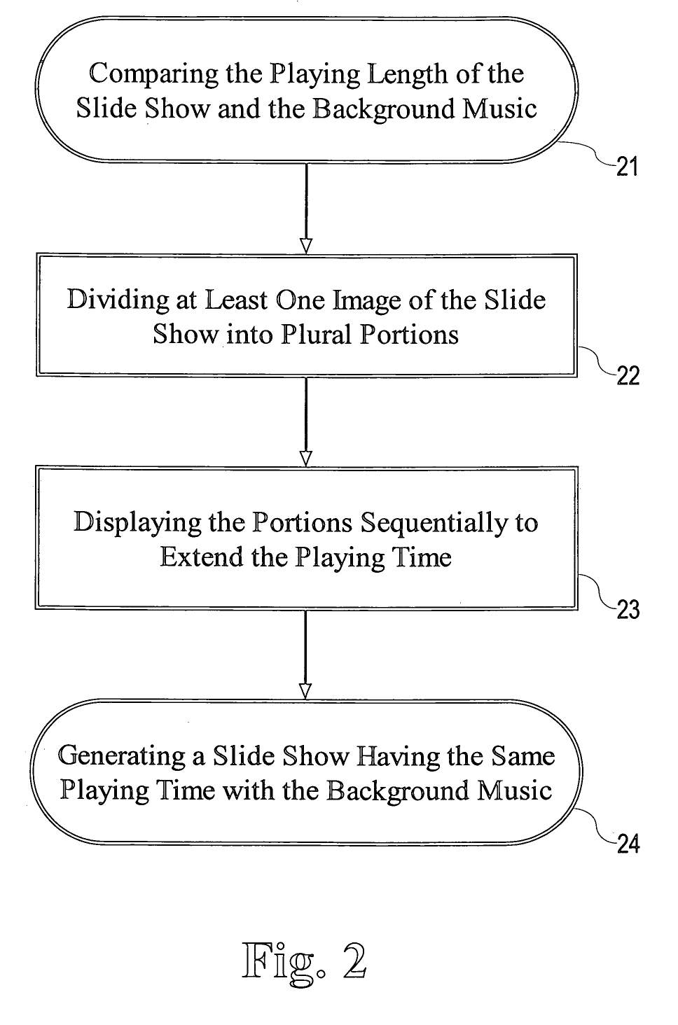

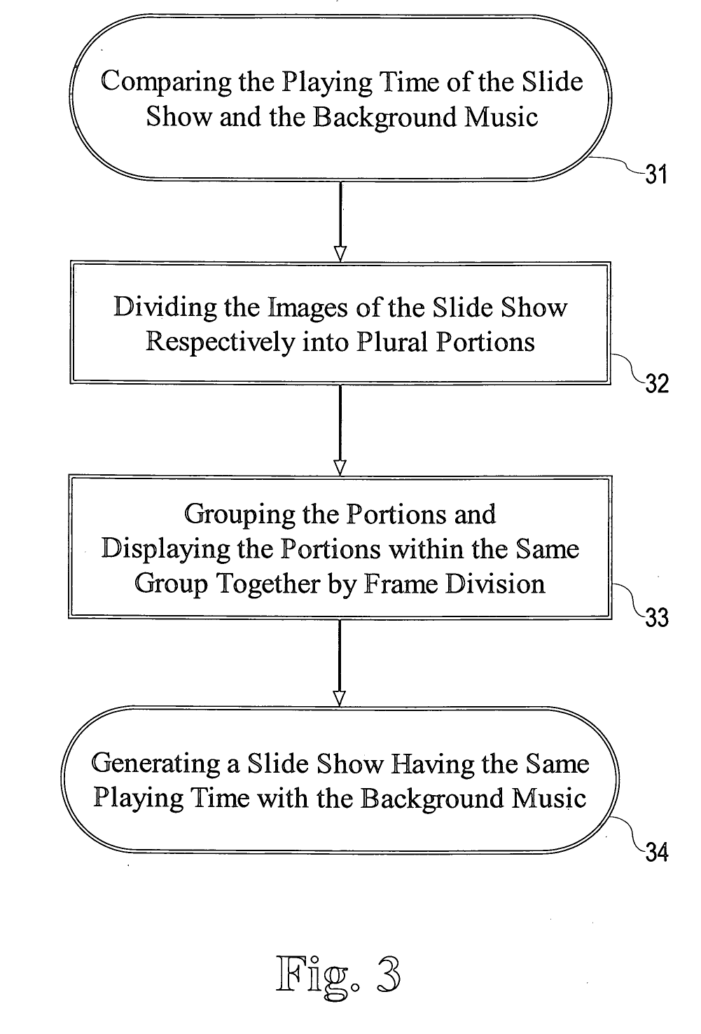

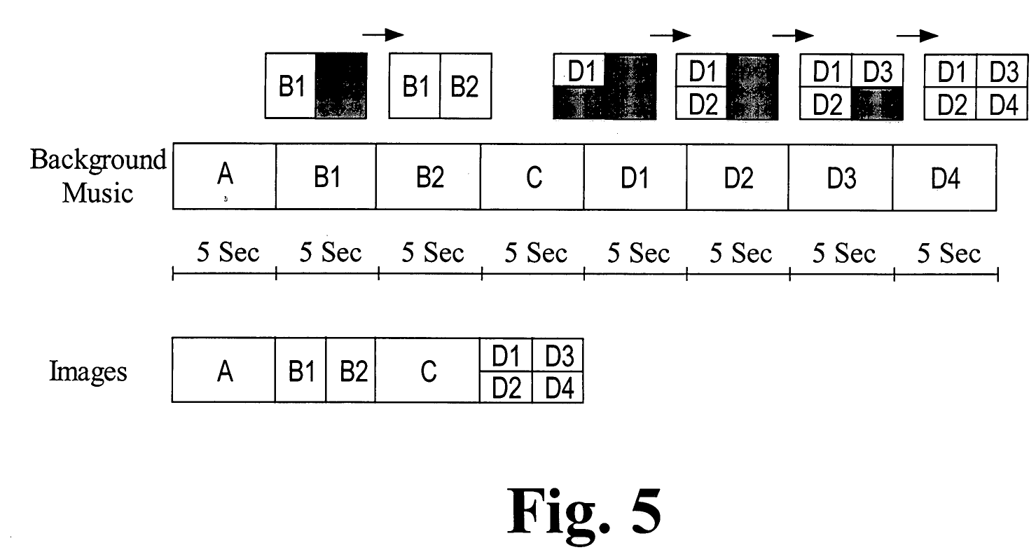

The present invention may otherwise divide the images in the slide show into plural sections, as shown in FIG. 2, FIG. 3 and FIG. 5.

In the method presented in FIG. 2, at least one image in the slide show would be divided into plural sections, as shown in step 22. Next, in step 23, these sections are displayed sequentially to extend the playing time of the divided image. In this way, the slide show could be adjusted to have the same playing time with the background music, as shown in step 24.

Referring FIG. 5, in the presented embodiment, the playing time of each image is five seconds. Four images are provided, which are image A to image D. Since the playing time of background music is forty seconds, image B and image C could be divided into plural sections, as shown in step 22. That is, image B is divided as section B1 and section B2, and image D is divided as section D1 to section D4, respectively. Therefore, these sections would be displayed sequentially in multiple stages, as shown in step 23. In other words, in the processing of displaying image B, the section B1 would be firstly displayed for five seconds, and then sections B1 and B2 are displayed concurrently (namely, the whole image B is displayed) for another five seconds, as shown in FIG. 5. In this way, the playing time of slide show could be extended for at least five seconds in the process of displaying image B. Image D is displayed in four stages, and the playing time of the slide show is extended for at least fifteen seconds. Besides, in this embodiment, since the background music is exactly twice as long as the slide show, it could still simply play the slide show twice.

Furthermore, as shown in the step 32 of FIG. 3, plural images in the slide show may be divided into plural sections, respectively. Then, in step 33, all sections are grouped. The sections in the same group, no matter whether come from the same image, would be displayed in certain frame jointly by the similar frame division. The technique of grouping is applied to adjust the playing time of the slide show. That is, in order to extend the playing time of the slide show, more groups would be obtained, and each group may include fewer sections. On the other hand, in order to shorten the playing time of the slide show, fewer groups would be obtained. Additionally, the sections could be included in more than one group, namely, the grouping of sections are not exclusive.

Because the division of the image may cause negative effect to the expression of the image, the semantic analysis is preferably performed before the division to detect the semantic regions, such as the human face, the neighborhood around the focus with predetermined area or the highly symmetrical region. These semantic regions, which are usually meaningful to the users, are preferably remained intact in the divided sections in order to keep the integrity of the slide show.

In addition, if the playing time of the background music is too short, the music could be played for two or more times, and the techniques mentioned above are then applied. The following formula may be adopted to calculate the appropriate playing times of the music:
(N_{image}×T_{image})+T_{audio}=N_{audio′}
wherein N_{image} is indicated to the total number of the images, T_{image} is referred to the playing time of each image, T_{audio} is the playing time of the background music, and N_{auido} is indicated to the playing times of the background music. If the obtained N_{auido} is not an integral, the decimal fraction is preferably omitted or carried to obtain proper playing times of the music. For example, in the embodiment shown in FIG. 4, the standard playing time of the images would be originally played for forty-five seconds (N_{image}×T_{image}=9×5), but the playing time of the music is merely twenty seconds (T_{audio}). The music would therefore be played twice (45÷20=2.25≈). The remaining five seconds would be cured by the above techniques, namely shortening the slide show for five seconds. In another example, if ten images are provided, the standard playing time of these images would be fifty seconds (N_{image}×T_{image}=10×5=50). Since the playing time of the music remained twenty seconds, the music would be played for three times (50÷20=2.5≈3). The excess ten seconds would be cured by the above techniques, to phrase another word, to extend the slide show for ten seconds.

With the methods provided by the present invention, the playing time of the slide show could be shortened or extended automatically to synchronize with that of the background music for meeting various demands. In particular, the integrity of the slide show and the background music could be retained appropriately.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method for synchronizing a slide show with background music, which comprises:
comparing the playing time of said slide show and the playing time of said background music, wherein said slide show includes a first segment and a second segment;
displaying each image of said first segment together with at least one image of said second segment by frame division; and
generating a new slide show having substantially the same playing time with said background music.

2. The method as set forth in claim 1, wherein said first segment is an exceeding segment of said slide show compared with said background music.

3. The method as set forth in claim 1, which further comprises:
calculating a difference between the playing time of said slide show and the playing time of said background music, and said new slide show is generated according to said difference.

4. The method as set forth in claim 1, wherein said frame division is implemented by dividing a frame of said slide show into plural portions, and a plurality of said images are dispatched to said portions respectively for displaying said plurality of images jointly in said frame.

5. The method as set forth in claim 4, wherein said plurality of images are displayed in said frame concurrently or sequentially.

6. The method as set forth in claim 4, wherein said plurality of images are zoomed or cropped respectively to fit said portions.

7. The method as set forth in claim 4, wherein said portions include a main portion which has larger area and is dispatched with said image which originally displayed in said frame.

8. The method as set forth in claim 1, wherein said slide show and said background music are respectively stored in a storage device.

9. The method as set forth in claim 1, wherein the number of playing times of said background music is calculated according the ratio of the playing time of said slide show and the playing time of said background music.

10. A method for synchronizing a slide show with background music, which comprises:
comparing the playing time of said slide show and the playing time of said background music;
dividing at least one image of said slide show into plural sections;
displaying said sections sequentially to extend the playing time of said image; and
generating a new slide show having the same playing time with said background music.

11. The method as set forth in claim 10, which further comprises:
calculating a difference between the playing time of said slide show and the playing time of said background music, and said new slide show is generated according to said difference.

12. The method as set forth in claim 10, wherein said image is divided according to the content therein, and a semantic region in said image is remained in one of said sections.

13. The method as set forth in claim 12, which further comprises:
performing semantic analysis for said image before dividing to detect said semantic region, wherein said semantic region includes a human face, a neighborhood around a focus with predetermined area or a highly symmetrical region.

14. The method as set forth in claim 10, wherein said slide show and said background music are stored respectively in a storage device.

15. The method as set forth in claim 10, wherein the number of playing times of said background music is calculated according the ratio of the playing time of said slide show and the playing time of said background music.

16. A method for synchronizing a slide show with background music, which comprises:
comparing the playing time of said slide show and the playing time of said background music;
dividing images of said slide show into plural sections and grouping said sections;
displaying said sections belonging to the same group jointly to adjust the playing time of said slide show; and
generating a new slide show having substantially the same playing time with said background music.

17. The method as forth in claim 16, which further comprises:
calculating a difference between the playing time of said slide show and the playing time of said background music, and said new slide show is generated according to said difference.

18. The method as set forth in claim 16, wherein said images are divided according to the content therein, and semantic regions in said images are remained in said sections.

19. The method as set forth in claim 18, which further comprises:
performing semantic analysis for said images before dividing to detect said semantic regions, wherein said semantic regions include a human face, a neighborhood around a focus with predetermined area or a highly symmetrical region.

20. The method as set forth in claim 16, wherein said frame division is implemented by dividing a frame of said slide show into plural portions, and said sections belonging to the same group are dispatched to said portions.

21. The method as set forth in claim 20, wherein said sections dispatched to said portions in said frame are displayed concurrently or sequentially.

22. The method as set forth in claim 20, wherein said sections dispatched to said portions are zoomed or cropped respectively to fit said portions.

23. The method as set forth in claim 16, wherein said slide show and said background music are stored respectively in a storage device.

24. The method as set forth in claim 16, wherein the number of playing times of said background music is calculated according the ratio of the playing time of said slide show and the playing time of said background music.
